(19) United States
(12) Patent Application Publication
(10) Pub. No.: US 2012/0307495 A1
(43) Pub. Date: Dec. 6, 2012

(54) OPTICAL LENS AND OPTICAL LENS PLATE

(75) Inventor: Wei-Wen Shih, Taoyuan County (TW)

(73) Assignee: LEOTEK ELECTRONICS CORPORATION, Taoyuan County (TW)

(21) Appl. No.: 13/154,269

(22) Filed: Jun. 6, 2011

(51) Int. Cl. F21V 5/04

(52) U.S. Cl. 362/237; 362/311.02

(57) ABSTRACT

An optical lens includes a incident curved surface, a cone-shaped body, and a emitting curved surface. Light emitted from a light emitting diode (LED) has a first refraction angle on a first plane and a second refraction angle on a second plane after passing through the incident curved surface, the cone-shaped body, and the emitting curved surface. The first refraction angle is between 105 degrees and 145 degrees, and the second refraction angle is between 38 degrees and 65 degrees. The light is asymmetrically distributed on the second plane. Therefore, when the optical lens is applied to a street lamp, the light utilization on a road side may be increased.

### BACKGROUND OF THE INVENTION

1. Field of Invention

The present invention relates to an optical lens and an optical lens plate, and more particularly to an optical lens and an optical lens plate capable of achieving asymmetric distribution of light on a second plane.

2. Related Art

With the enhancement of people's awareness of environmental protection, various green electronic products have received attention according to the energy-saving and carbon-reduction effect. Due to characteristics of small volume, high brightness, long service life, and low power consumption, light emitting diode (LED) become an outstanding lighting appliance in the world wide. For example, the LED is used as a light source of traffic lights and flashlights in daily life. In addition to the application in traffic lights and flashlights, the LED can also be applied to street lamps.

Light emitted from the LED should meet requirements of a specific light distribution for street lamp lighting. An optical lens plate, mechanism design and arrangement are used to enable the light emitted from the LED to meet the requirement for a particular light distribution. The light distribution is an illuminated range formed by light projected from a lighting device on a road surface.

Persons skilled in the art proposed an LED street lamp meeting the requirement for different light distributions by means of an optical lens plate or arrangement. But in this method, a combination of more than two kinds of optical lenses needs to be adopted, and different kinds of optical lenses need to cooperate with each other in accordance with a certain ratio to achieve the required light distribution. Therefore, problems of excessively high cost of mold design and increasing development and test time due to ratio adjustment exist. Moreover, FIG. 1A is a schematic cross-sectional structural view of an embodiment wherein a conventional LED street lamp uses an optical lens plate to meet requirements for different light distributions. In this embodiment, an LED street lamp 10 includes a plurality of LEDs 12 and an optical lens plate 14, and the optical lens plate 14 includes a plurality of optical lenses 16 and a substrate 18. Each optical lens 16 is disposed on the substrate 18, and the optical lenses 16 correspond to the LEDs 12. light 19 which has the large incident angle emitted from each LED 12 may be easily lost due to total reflection of the light 19 caused by the forming thickness requirement of the optical lens plate 14 (that is, the substrate 10 needs to have a certain thickness), thereby reducing the light-emitting efficiency of the optical lens plate 14.

Furthermore, FIG. 1B is a schematic view for illustrating use of an embodiment of a conventional LED street lamp on a first plane, FIG. 1C is a schematic view for illustrating use of the embodiment of the conventional LED street lamp on a second plane, FIG. 1D is a luminous intensity distribution curve of the embodiment of the conventional LED street lamp, and FIG. 1E is a schematic view illustrating a relation between a road side and a non-road side of light utilization of the embodiment of the conventional LED street lamp. In this embodiment, a light distribution on the first plane (that is, a dotted line in FIG. 1D, namely, the light distribution on a Y-Z plane) and a light distribution on the second plane (that is, the light distribution shown by a solid line in FIG. 1D, namely, the light distribution on an X-Z plane) of the LED street lamp are both substantially symmetric light distribution. However, the utilization of the LED street lamp with a symmetric light distribution on the road side (that is, a dotted line SS in FIG. 1E) to that on the non-road side (that is, a solid line HS in FIG. 1E) is about 50% to 50% (for example, one half of the light is projected to the road surface, and the other half of the light is projected to a building or a rice field), thereby causing light pollution to the non-road side (for example, the light projected to the building will interfere with the quality of human sleep or the light projected to the rice field will interfere with the growth of paddy rice.).

In order to solve the problems, the conventional LED street lamp employs adjustment of the mechanism design (for example, increasing an elevation angle of the LED street lamp) to meet the requirement for a specific light distribution. Therefore, problems that the design is complex and the assembly and production is not easy exist, thereby increasing the manufacturing cost of the street lamp.

### SUMMARY OF THE INVENTION

Accordingly, the present invention is an optical lens and an optical lens plate, which can solve problems such as light pollution, low light utilization, and high manufacturing cost due to a complex design in the prior art when being applied in a street lamp.

The present invention provides an optical lens, which is applicable for receiving light emitted from an LED, wherein the LED comprises a first optical axis. In an embodiment, the optical lens comprises an incident curved surface, a cone-shaped body, and an emitting curved surface. The incident curved surface is used for receiving the light, and the light has a first refraction angle on a first plane and a second refraction angle on a second plane after passing through the incident curved surface, the cone-shaped body, and the emitting curved surface. The first refraction angle is between 105 degrees and 145 degrees, the second refraction angle is between 38 degrees and 65 degrees, and the light is asymmetrically distributed on the second plane.

In an embodiment of the optical lens, the cone-shaped body comprises a first surface and a second surface, there is a first angle between the first surface and the second surface, and the first angle is between 10 degrees and 65 degrees.

In an embodiment of the optical lens, the incident curved surface comprises a second incident curved surface, the second incident curved surface comprises a first curved line, the first curved line comprises two first end points, there is a second angle between a connecting line between the first end points and the second surface, and the second angle is between 30 degrees and 60 degrees.

In an embodiment of the optical lens, the optical lens further comprises a lead angle surface, the lead angle surface may comprises a first line segment, and the first line segment comprises two second end points. There is a third angle between a connecting line between the second end points and the first optical axis, and the third angle is between 20 degrees and 50 degrees.

In an embodiment of the optical lens, the emitting curved surface is an M-shaped curved surface, the M-shaped curved surface comprises a central axis, and the central axis coincides with the first optical axis.

The present invention provides an optical lens plate, which is applicable to a lamp, the lamp has a plurality of light emitting diodes (LEDs), each LED comprises a first optical axis and is used for emitting light. In an embodiment, the optical lens plate comprises a substrate and a plurality of optical lenses, each optical lens is disposed on the substrate, and the optical lenses correspond to the LEDs. Each optical lens comprises an incident curved surface, a cone-shaped body, and a emitting curved surface. The incident curved surface is used for receiving the light, and the light has a first refraction angle on a first plane and a second refraction angle on a second plane after passing through the incident curved surface, the cone-shaped body, and the emitting curved surface. The first refraction angle is between 105 degrees and 145 degrees, the second refraction angle is between 38 degrees and 65 degrees, and the light is asymmetrically distributed on the second plane.

In an embodiment of the optical lens plate, the cone-shaped body comprises a first surface and a second surface, there is a first angle between the first surface and the second surface, and the first angle is between 10 degrees and 65 degrees.

In an embodiment of the optical lens plate, the incident curved surface comprises a second incident curved surface, the second incident curved surface comprises a first curved line, and the first curved line comprises two first end points. There is a second angle between a connecting line between the first end points and the second surface, and the second angle is between 30 degrees and 60 degrees.

In an embodiment of the optical lens plate, the optical lens further comprises a lead angle surface, the lead angle surface may comprises a first line segment, and the first line segment comprises two second end points. There is a third angle between a connecting line between the second end points and the third optical axis and is between 20 degrees and 50 degrees.

In an embodiment of the optical lens plate, the emitting curved surface is an M-shaped curved surface, the M-shaped curved surface comprises a central axis, and the central axis coincides with the first optical axis.

With the optical lens and the optical lens plate of the present invention, the second refraction angle on the second plane is changed through adjustment of a relative relation between the incident curved surface, the cone-shaped body and the design of the cone-shaped body. With the design of the lead angle surface, the utilization of the light is increased. Through adjustment of a relative relation between the light guide angle and the LED and a relative relation between the incident curved surface and the emitting curved surface, the first refraction angle on the first plane is changed. The optical lens plate of the present invention is applicable to a lamp, wherein an asymmetric light intensity distribution is achieved through the design of a single type of optical lens. Therefore, the luminous intensity distribution curve of the optical lens and the optical lens plate of the present invention has an asymmetric light distribution, so that the problems such as light pollution, low light utilization, and high manufacturing cost due to a complex design in the prior art can be solved when the optical lens and the optical lens plate of the present invention are applied to a street lamp.

### BRIEF DESCRIPTION OF THE DRAWINGS

The present invention will become more fully understood from the detailed description given herein below for illustration only, and thus are not limitative of the present invention, and wherein:

FIG. 1A is a schematic cross-sectional structural view of an embodiment in which a conventional LED street lamp uses a lens plate to meet requirements for different light distribution;

FIG. 1B is a schematic view for illustrating use of an embodiment of a conventional LED street lamp on a first plane;

FIG. 1C is a schematic view for illustrating use of the embodiment of the conventional LED street lamp on a second plane;

FIG. 1D is a luminous intensity distribution curve of the conventional LED street lamp according to an embodiment;

FIG. 1E is a schematic view illustrating a relation between a road side and a non-road side of light utilization of the embodiment of the conventional LED street lamp;

FIG. 2A is a schematic three-dimensional structural view of an embodiment of an optical lens plate of the present invention;

FIG. 2B is a schematic cross-sectional structural view along line 2B-2B of FIG. 2A;

FIG. 2C is a schematic structural cross-sectional view along line 2C-2C of FIG. 2A;

FIG. 3A is a schematic structural view of an embodiment wherein the optical lenses board in FIG. 2B is applied to a lamp;

FIG. 3B is a schematic structural view of an embodiment wherein the optical lens plate in FIG. 2C is applied to a lamp;

FIG. 4 is a schematic view of a first refraction angle and a second refraction angle of an embodiment of the optical lens in FIG. 2A;

FIG. 5A is a luminous intensity distribution curve in which a first angle in FIG. 3A is 10 degrees;

FIG. 5B is a luminous intensity distribution curve in which the first angle in FIG. 3A is 25 degrees;

FIG. 5C is a luminous intensity distribution curve in which the first angle in FIG. 3A is 40 degrees;

FIG. 5D is a luminous intensity distribution curve in which the first angle in FIG. 3A is 60 degrees;

FIG. 5E is a luminous intensity distribution curve in which the first angle in FIG. 3A is 65 degrees;

FIG. 6A is a luminous intensity distribution curve in which a second angle in FIG. 3A is 30 degrees;

FIG. 6B is a luminous intensity distribution curve in which the second angle in FIG. 3A is 35 degrees;

FIG. 6C is a luminous intensity distribution curve in which the second angle in FIG. 3A is 60 degrees;

FIG. 7A is a schematic structural view of a first embodiment of an optical lens of the present invention;

FIG. 7B is a schematic structural view of a second embodiment of the optical lens of the present invention;

FIG. 7C is a schematic structural view of a third embodiment of the optical lens of the present invention;

FIG. 8A is a luminous intensity distribution curve of the optical lens in FIG. 7A;

FIG. 8B is a luminous intensity distribution curve of the optical lens in FIG. 7B;

FIG. 8C is a luminous intensity distribution curve of the optical lens in FIG. 7C;

FIG. 9 is a schematic structural views of another embodiment in which the optical lens plate of the present invention is applied to a lamp;

FIG. 10A is a schematic structural view of a fourth embodiment of the optical lens of the present invention;

FIG. 10B is a schematic structural view of a fifth embodiment of the optical lens of the present invention;

FIG. 10C is a schematic structural view of a sixth embodiment of the optical lens of the present invention;

FIG. 11A is a luminous intensity distribution curve of the optical lens in FIG. 10A;

FIG. 11B is a luminous intensity distribution curve of the optical lens in FIG. 10B; and

FIG. 11C is a luminous intensity distribution curve of the optical lens in FIG. 10C.

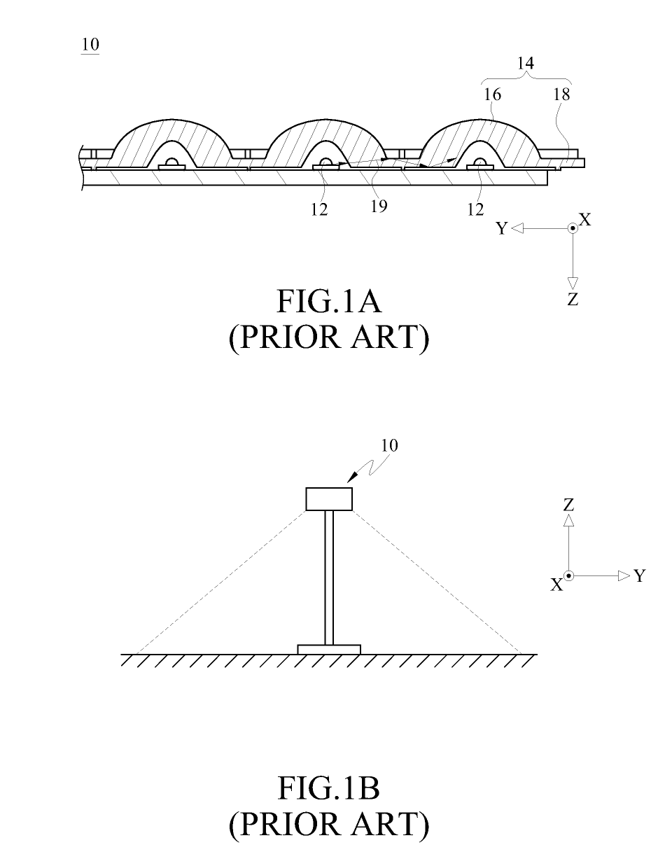

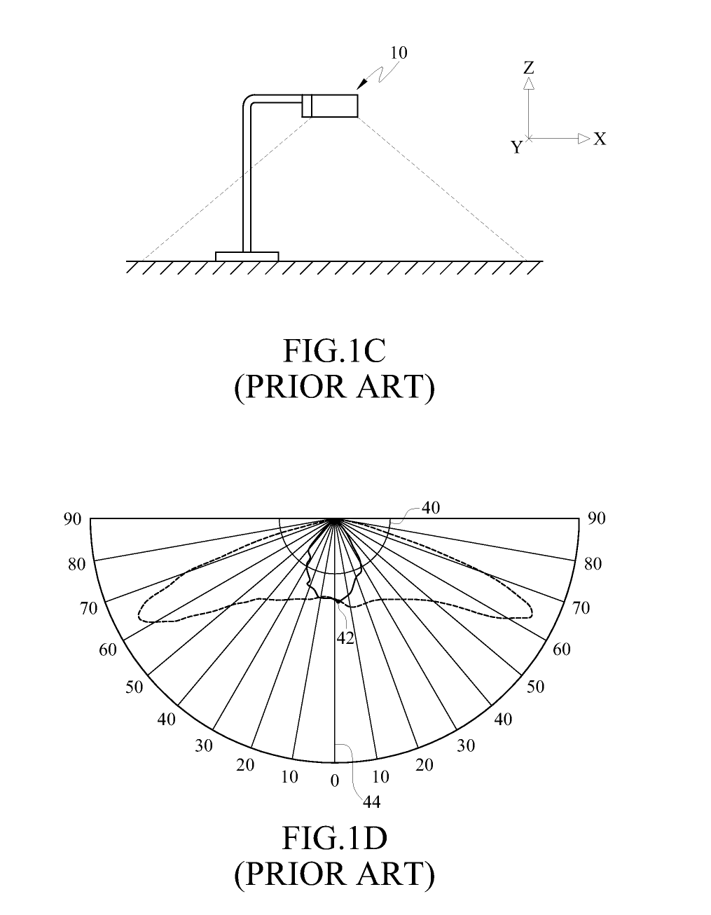

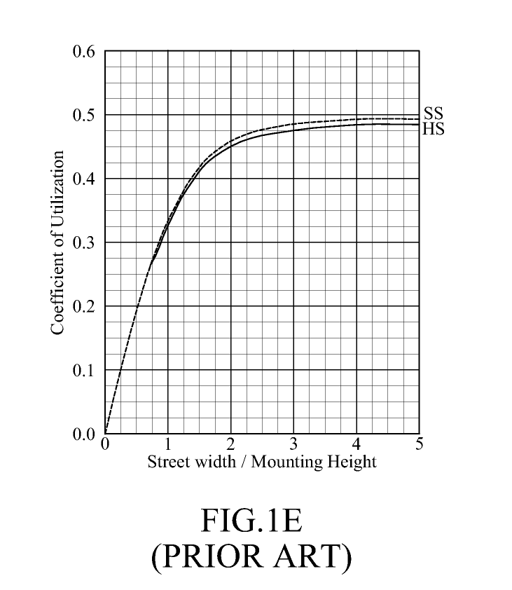

### DETAILED DESCRIPTION OF THE INVENTION

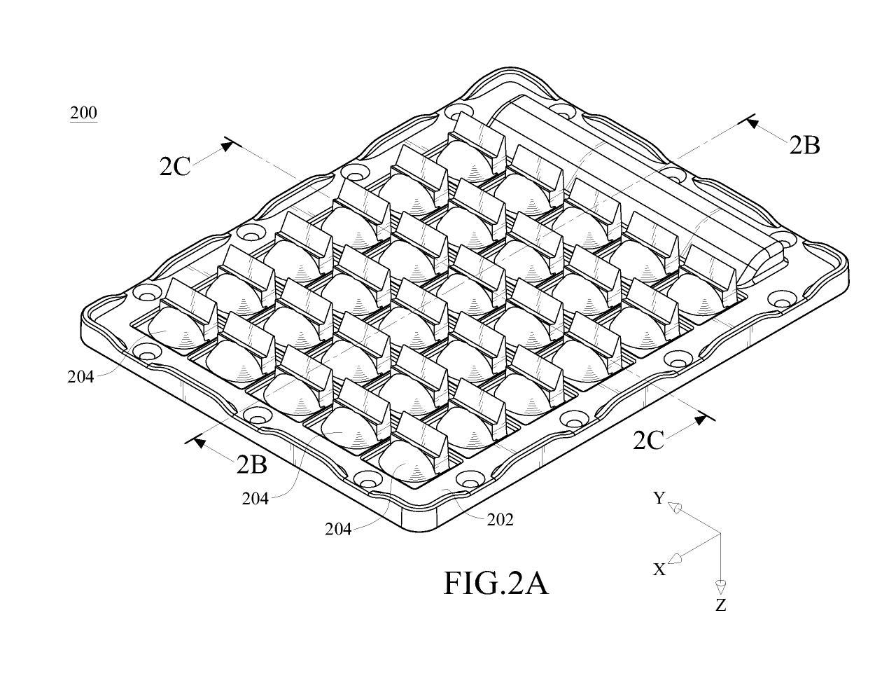

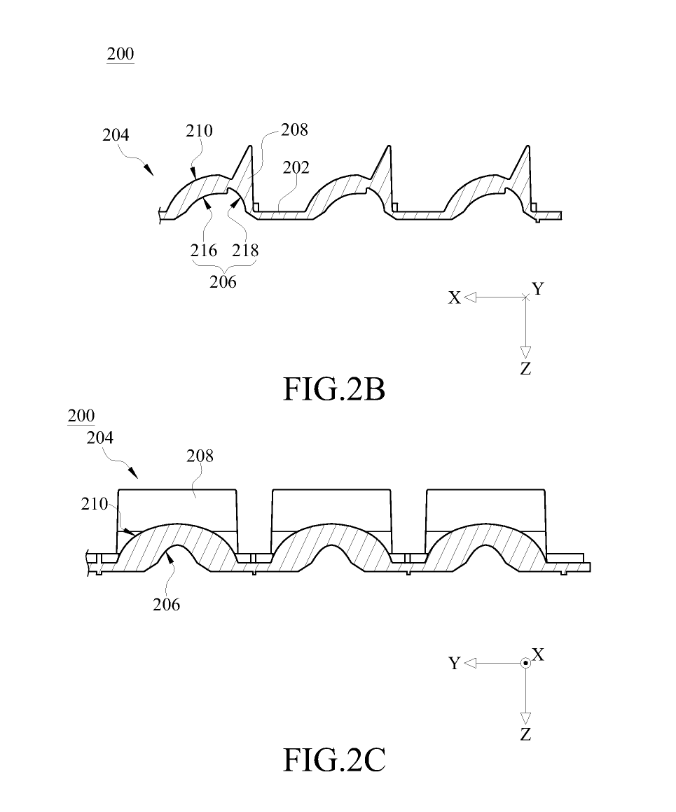

FIG. 2A is a schematic three-dimensional structural view of an embodiment of an optical lens plate of the present invention, and FIG. 2B is a schematic cross-sectional structural view along line 2B-2B of FIG. 2A. Referring to FIGS. 2A and 2B, in this embodiment, an optical lens plate 200 comprises a substrate 202 and thirty optical lenses 204, wherein the thirty optical lenses 204 are disposed on the substrate 202 in a 5×6 array (that is, a number of the optical lenses 204 disposed along a second axial direction Y is 5, and a number of the optical lenses 204 disposed along a first axial direction X is 6), but this embodiment is not intended to limit the present invention. That is, the number and the arrangement of the optical lenses 204 can be adjusted as required. Each optical lens 204 comprises an incident curved surface 206, a cone-shaped body 208, and an emitting curved surface 210. The emitting curved surface 210 may be, but not limited to, an elliptical curved surface (referring to FIG. 2C, which is a schematic cross-sectional view along line 2C-2C of FIG. 2A). That is to say, the emitting curved surface 210 may also be an M-shaped curved surface, and the details will be described below.

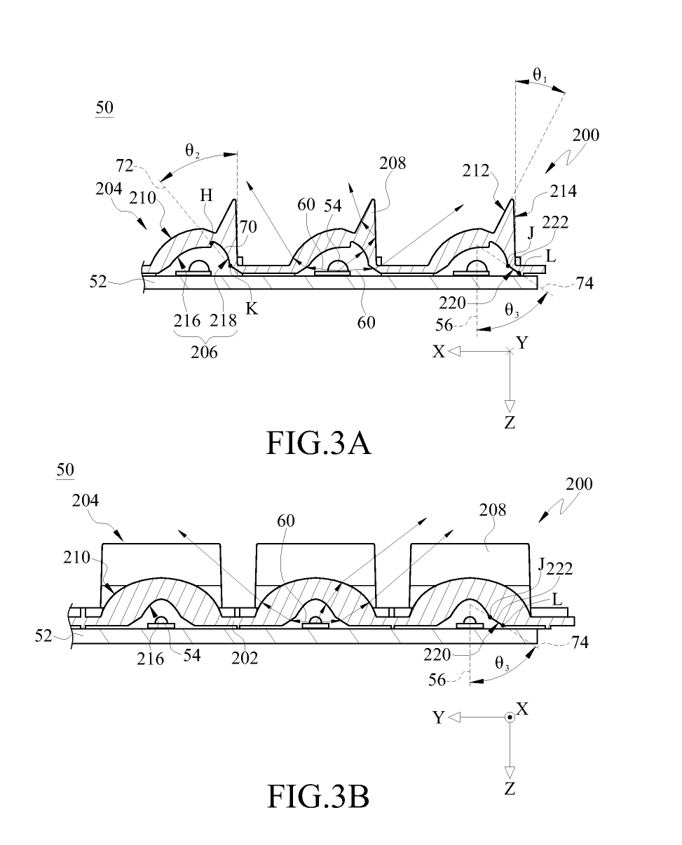

FIG. 3A is a schematic structural view of an embodiment in which the optical lenses board in FIG. 2B is applied to a lamp, and FIG. 3B is a schematic structural view of an embodiment in which the optical lens plate in FIG. 2C is applied to a lamp. Referring to FIGS. 2B and 2C, in this embodiment, a lamp 50 comprises a circuit board 52 and an optical lens plate 200, wherein the optical lens plate 200 is disposed on the circuit board 52. The circuit board 52 may have thirty LEDs 54. Each optical lens 204 may correspond to each LED 54, that is, the lenses 204 can correspond to the LEDs 54 in a one-to-one relation, but this embodiment is not intended to limit the present invention. Each LED 54 is used for emitting light 60 and comprises a first optical axis 56. The incident curved surface 206 is used for receiving the light 60.

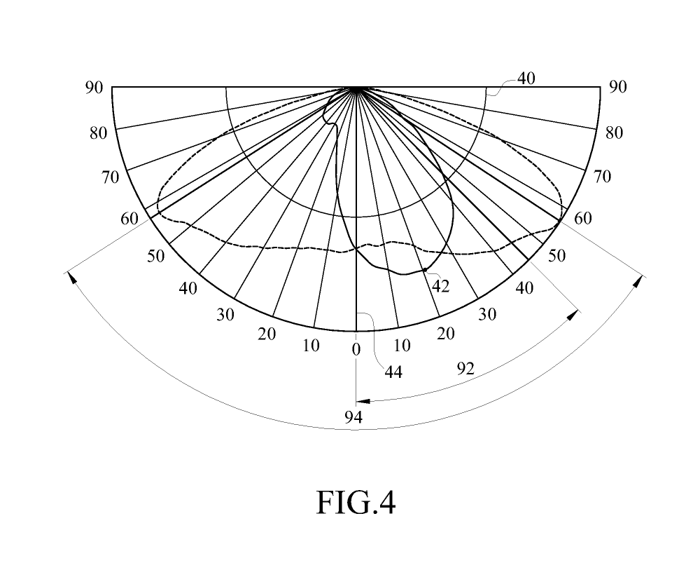

Since each of the optical lenses 204 in the optical lens plate 200 may has the same design, a single optical lens 204 is taken as an example for description. FIG. 4 is a luminous intensity distribution curve of an embodiment of the optical lens in FIG. 2A. In FIG. 4, the center of a circle is a position where a light source (the LED 54) is located, a concentric arc 40 represents two thirds of a maximum light intensity 42 of the light 60 on a second plane (that is, an X-Z plane) after the light 60 passes through the optical lens 204, and radial lines represent an angle with a vertical line 44 passing through the light source (for example, 0, 10, 20, 30, 40, 50, 60, 70, 80, and 90 degrees in FIG. 4). A first refraction angle 92 is an angle between a line connecting the center of the circle with a maximum luminous intensity at the right side of the vertical line 44 and another line connecting the center of the circle with a maximum luminous intensity at the left side of the vertical line 44 in the light intensity distribution on the first plane (that is, a dotted line in FIG. 4, namely, a Y-Z plane), and a second refraction angle 94 is an angle formed by the light intensity distribution of the light 60 on the second plane (that is, a solid line in FIG. 4, namely, an X-Z plane) and the concentric arc 40 at the right side of the vertical line 44, that is, an angle of the luminous intensity distribution on the second plane greater than two thirds of the maximum light intensity 42 at the right side of the vertical line 44.

The relative relation among the incident curved surface 206, the cone-shaped body 208, and the emitting curved surface 210 may influence the first refraction angle 92 of the light 60 on the first plane (that is, the Y-Z plane) and the second refraction angle 94 of the light 60 on the second plane (that is, the X-Z plane), and the details will be described later.

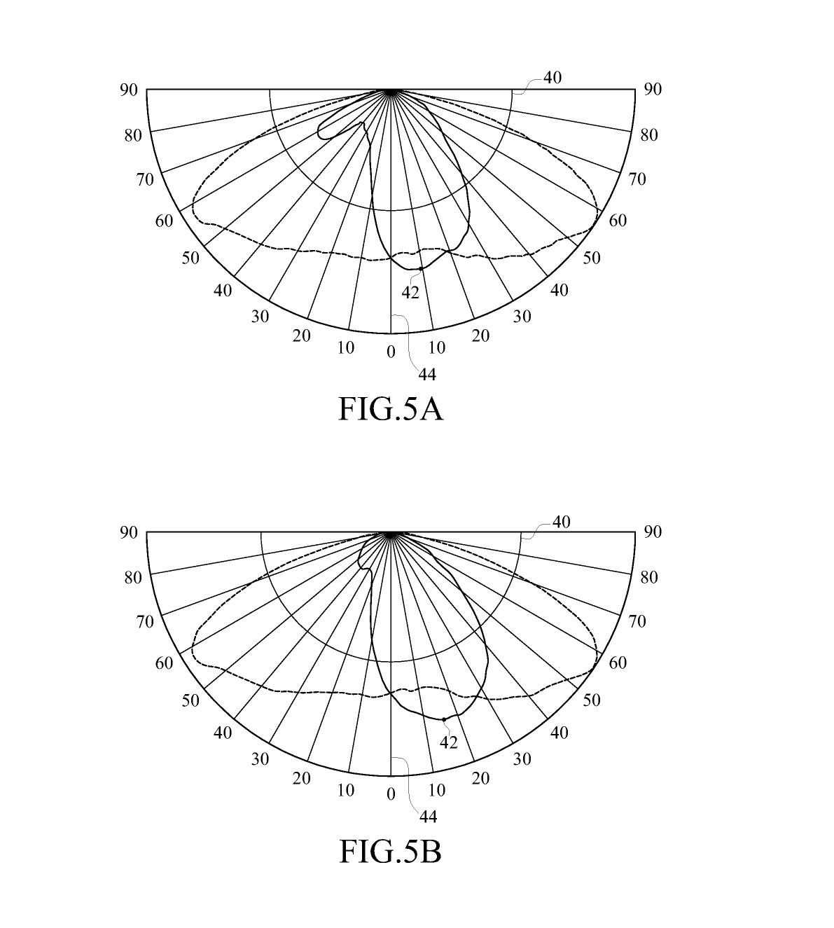

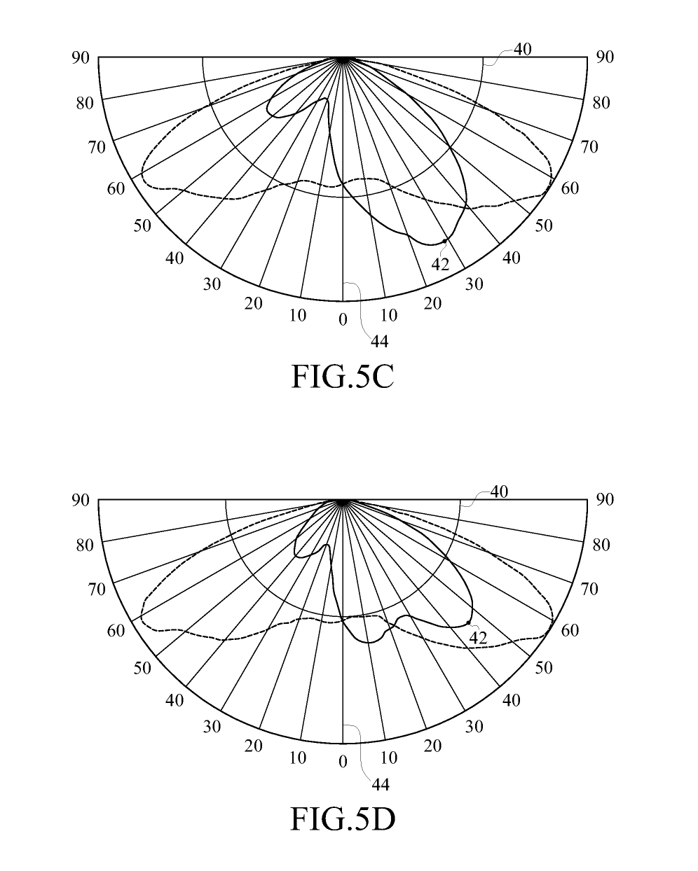

Referring to FIG. 3A, the cone-shaped body 208 comprises a first surface 212 and a second surface 214, wherein there is a first angle θ1 between the first surface 212 and the second surface 214. The first angle θ1 may be between 10 degrees and 65 degrees (that is, 10° θ1 65°), so that the light intensity distribution of the light 60 on the second plane (that is, the X-Z plane) is asymmetric. FIGS. 5A, 5B, 5C, 5D, and 5E are luminous intensity distribution curves in which the first angle in FIG. 3A is 10 degrees, 25 degrees, 40 degrees, 60 degrees, and 65 degrees respectively. Different first angles θ1 correspond to different first refraction angles 92 and different second refraction angles 94, and detailed results are shown in Table 1.

TABLE 1

| First angle | First refraction angle | Second refraction angle |
|---|---|---|
| (degrees) | (degrees) | (degrees) |
| 10 | 115 | 38 |
| 25 | 115 | 44 |
| 40 | 115 | 46 |
| 60 | 116 | 62 |
| 65 | 116 | 65 |

It can be known form Table 1 that, when the first angle θ1 becomes larger, the second refraction angle 94 of the light 60 after the light 60 passes through the optical lens 204 increases accordingly. When the optical lens 204 is applied to a street lamp, since the second refraction angle 94 is the distribution of the light 60 at the road side, an optical lens 204 having a larger first angle θ1 can project the light 60 to a wider road area. In other words, the optical lens 204 having the larger first angle θ1 is applicable to a street lamp for multilane roads.

Moreover, referring to FIG. 3A, the incident curved surface 206 further comprises a first incident curved surface 216 and a second incident curved surface 218, wherein the second incident curved surface comprises a first curved line 70. The first curved line 70 comprises two first end points H and K. There is a second angle θ2 between a connecting line 72 between the first end points H and K and the second surface 214.

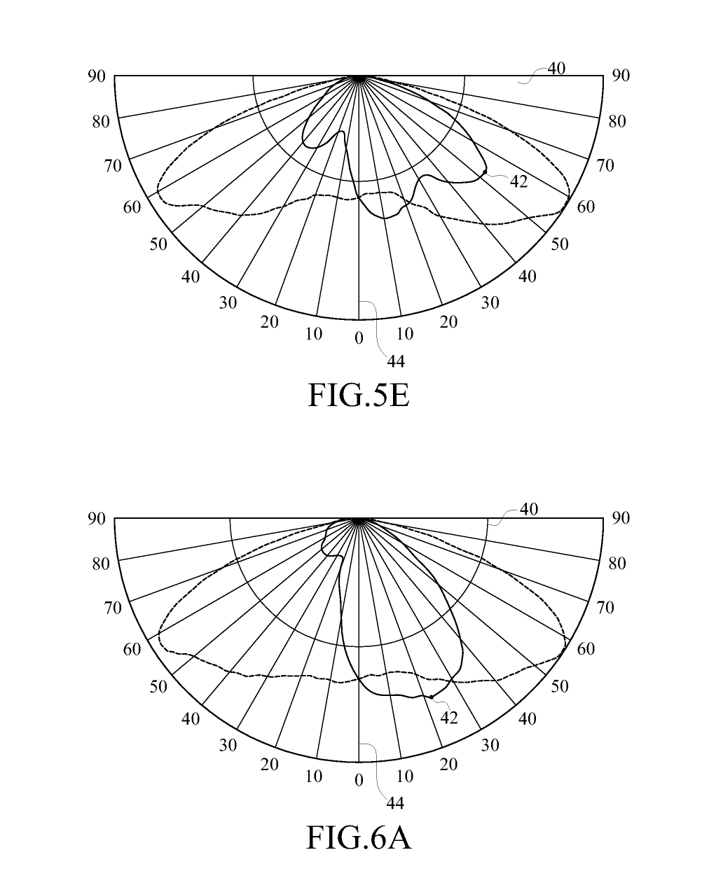

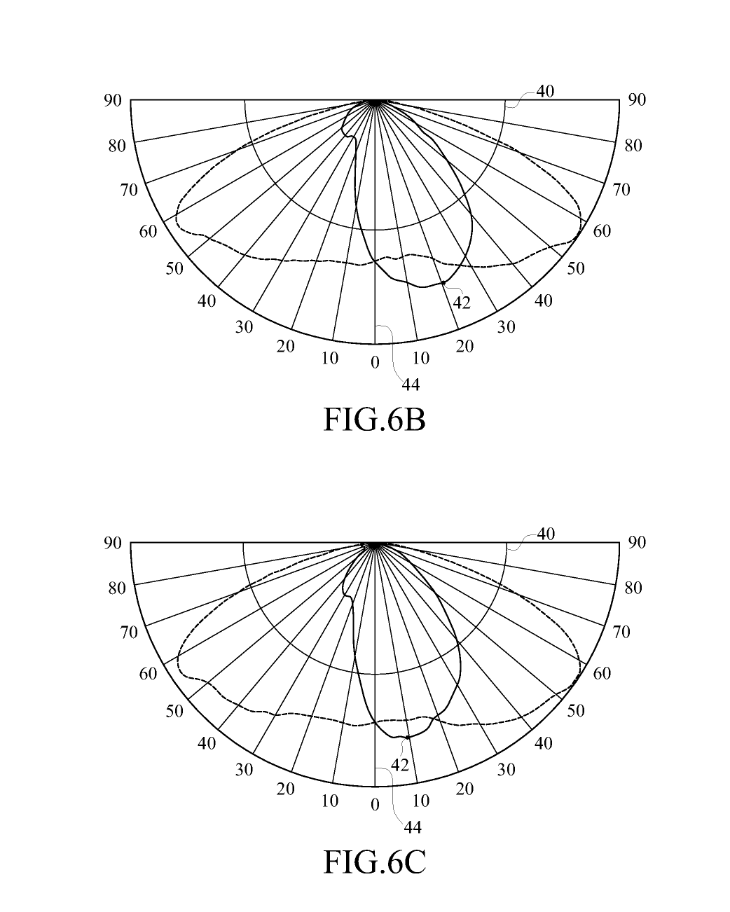

The second angle θ2 may be greater than or equal to 30 degrees and less than or equal to 60 degrees (that is, 30° θ2 60°), so that the luminous intensity distribution of the light 60 on the second plane (that is, the X-Z plane) is asymmetric. FIGS. 6A, 6B, and 6C are luminous intensity distribution curves in which the second angle in FIG. 3A is 30 degrees, 35 degrees and 60 degrees respectively. Different second angles θ1 correspond to different first refraction angles 92 and different second refraction angles 94, and detailed results are shown in Table 2.

TABLE 2

| Second angle | First refraction angle | Second refraction angle |
|---|---|---|
| (degrees) | (degrees) | (degrees) |
| 30 | 114 | 45 |
| 35 | 115 | 43 |
| 60 | 114 | 39 |

It can be known form Table 2 that, when the second angle θ2 becomes larger, the second refraction angle 94 of the light 60 after the light 60 passes through the optical lens 204 decreases accordingly. When the optical lens 204 is applied to a street lamp, since the second refraction angle 94 is the luminous intensity distribution of the light 60 at the road side, an optical lens 204 having a smaller second angle θ1 can project the light 60 to a wider road area. In other words, the optical lens 204 having the smaller second angle θ1 is applicable to the street lamp for multilane roads.

Referring to FIG. 3B, the optical lens 204 further comprises a lead angle surface 220. In this embodiment, the lead angle surface 220 may be a plane, so that after passing through the lead angle surface 220, the large-angle light 60 (for example, the light 60 with an angle between the light 60 and the first optical axis 56 of 85-90 degrees) can be emitted out from the optical lens 204 via the emitting curved surface 210, thereby increasing the utilization of the light 60, but this embodiment is not intended to limit the present invention, that is, the lead angle surface 220 may also be a curved surface.

Moreover, the lead angle surface 220 comprises a first line segment 222, in which the first line segment 222 comprises two second end points J and L. There is a third angle θ3 between a connecting line 74 between the second end points J and L and the first optical axis 56. In this embodiment, since the lead angle surface 220 is a plane, the first line segment 222 coincides with the connecting line 74 between the second end points J and L, but this embodiment is not intended to limit the present invention. The third angle θ3 may be greater than or equal to 20 degrees and less than or equal to 50 degrees (that is, 20° θ3 50°), so that the light 60 is emitted out from the optical lens 204, thereby increasing the utilization of the light 60. Different third angles θ3 correspond to different relative light utilization, and detailed results are shown in Table 3.

TABLE 3

| Third angle | Relative light utilization |
|---|---|
| (degrees) | (%) |
| 0 | 100 |
| 20 | 101 |
| 35 | 102 |
| 50 | 102.4 |

It can be known form Table 3 that, when the third angle θ3 becomes larger, the relative utilization of the light 60 after the light 60 passes through the optical lens 204 increases accordingly.

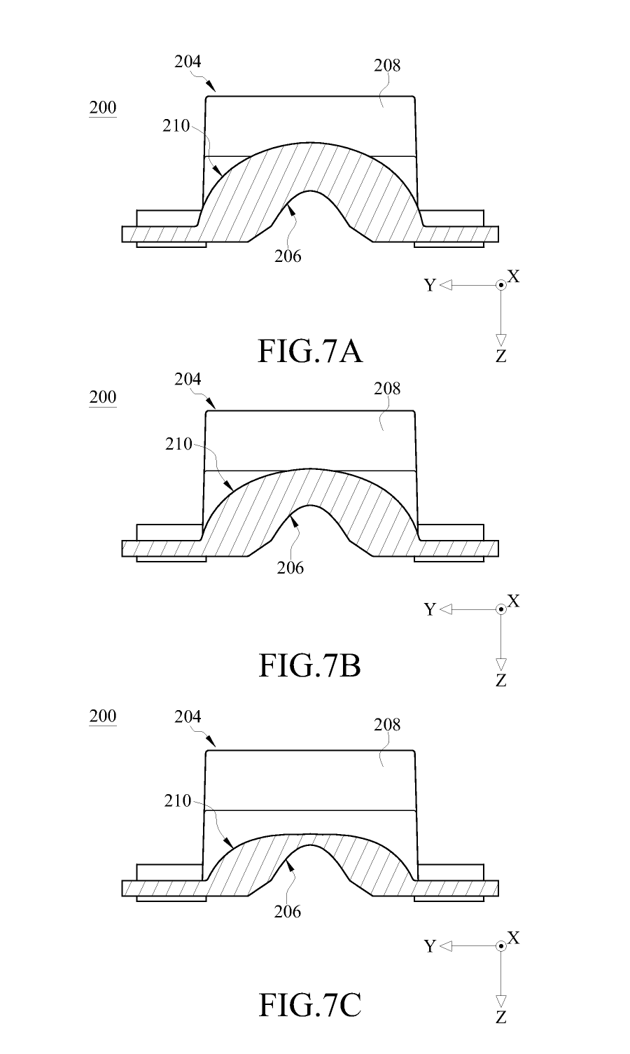

Furthermore, the relative relation between the incident curved surface 206 and the emitting curved surface 210 influences the range of the first refraction angle 92 of the light 60 on the first plane (that is, the Y-Z plane). FIGS. 7A, 7B, and 7C are schematic structural views of a first, a second, and a third embodiment of the optical lens of the present invention respectively. It can be found from FIGS. 7A, 7B, and 7C that, the difference between the three optical lenses lies in different relative distances between the incident curved surface 206 and the emitting curved surface 210, wherein the relative distance between the incident curved surface 206 and the emitting curved surface 210 in FIG. 7A is larger than that in FIG. 7B, and the relative distance between the incident curved surface 206 and the emitting curved surface 210 in FIG. 7B is larger than that in FIG. 7C. The relative distance is a shortest distance between the incident curved surface 206 and the emitting curved surface 210.

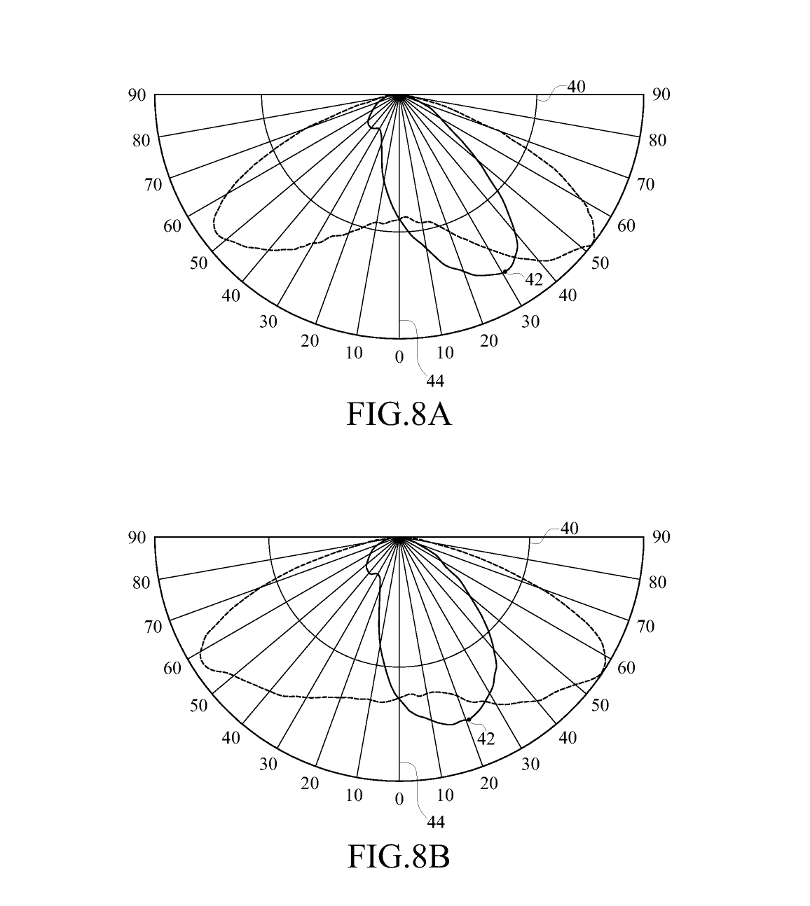

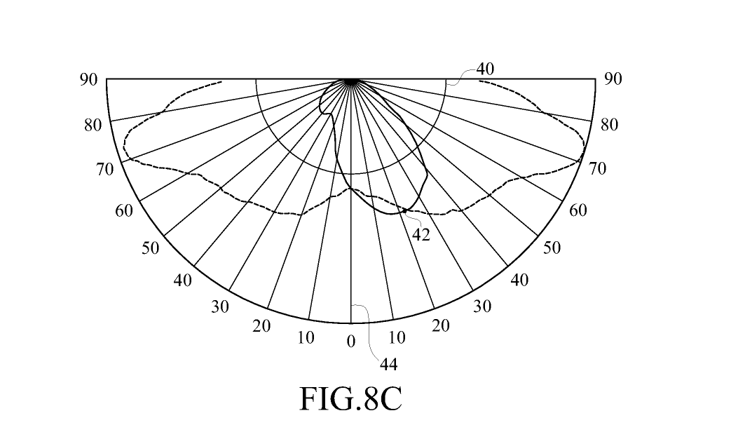

The optical lens 204 may influence the luminous intensity distribution of the light 60 after the light 60 passes through the optical lens 204 with the different relative distances between the incident curved surface 206 and the emitting curved surface 210. FIGS. 8A, 8B, and 8C are luminous intensity distribution curves of the optical lens in FIGS. 7A, 7B, and 7C respectively. The optical lenses 204 of the first embodiment, the second embodiment and the third embodiment have different first refraction angles 92 and different second refraction angles 94 respectively, and detailed results are shown in Table 4.

TABLE 4

| | First refraction angle | Second refraction angle |
|---|---|---|
| | (degrees) | (degrees) |
| First embodiment | 105 | 42 |
| Second embodiment | 115 | 43 |
| Third embodiment | 145 | 44 |

It can be known from Table 4 that, as the relative distance between the incident curved surface 206 and the emitting curved surface 210 decreases, the first refraction angle 92 of the light 60 on the first plane (that is, the Y-Z plane) becomes larger. When the optical lens 204 is applied to a street lamp, since the first refraction angle 92 is the luminous intensity distribution of the light 60 in a length direction of the road, so that an optical lens 204 having a shorter relative distance between the incident curved surface 206 and the emitting curved surface 210 can project the light 60 to a longer road length, so as to increase an interval between two adjacent street lamps arranged in a second axial direction (that is, a Y direction), thereby decreasing the number of the street lamps arranged.

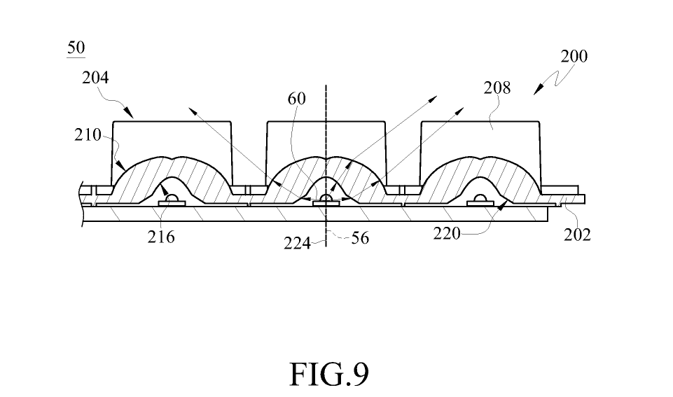

In the above embodiments, the emitting curved surface 210 is the wlliptical curved surface, but the emitting curved surface 210 may also be an M-shaped curved surface. FIG. 9 is a schematic structural view of another embodiment in which an optical lens plate of the present invention is applied to a lamp. In this embodiment, the M-shaped curved surface (that is, the emitting curved surface 210) comprises a central axis 224, wherein the central axis may coincide with the first optical axis 56, but this embodiment is not intended to limit the present invention.

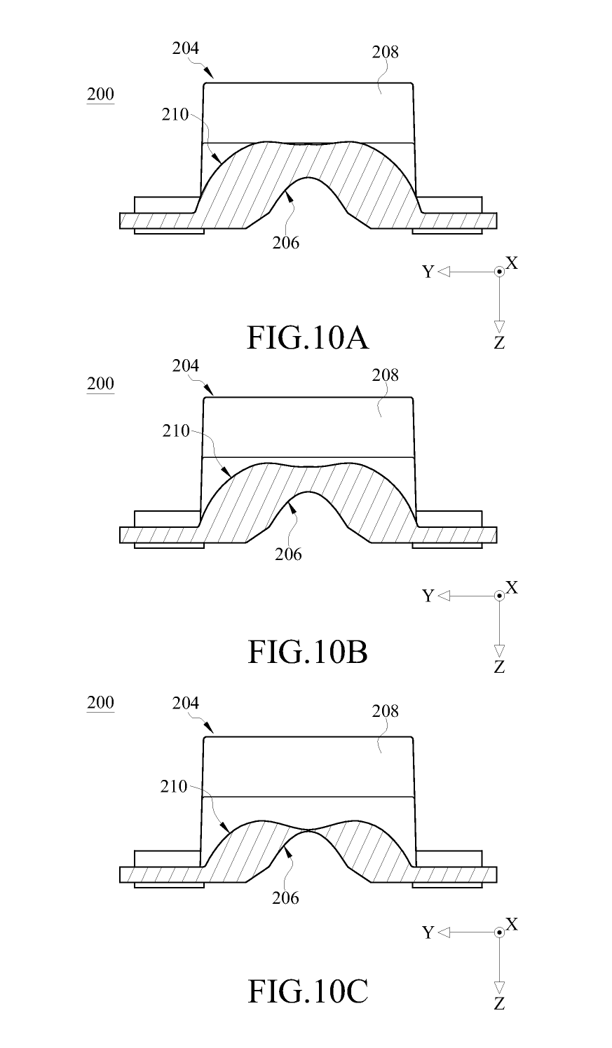

FIGS. 10A, 10B, and 10C are schematic structural views of a fourth embodiment, a fifth embodiment and a sixth embodiment of the optical lens of the present invention respectively. It can be found from FIGS. 10A, 10B, and 10C that, the difference between the three optical lenses lies in different relative distances between the incident curved surface 206 and the emitting curved surface 210, and the emitting curved surfaces 210 in the FIGS. 10A, 10B, and 10C are the M-shaped curved surfaces. The relative distance is a shortest distance between the incident curved surface 206 and the emitting curved surface 210.

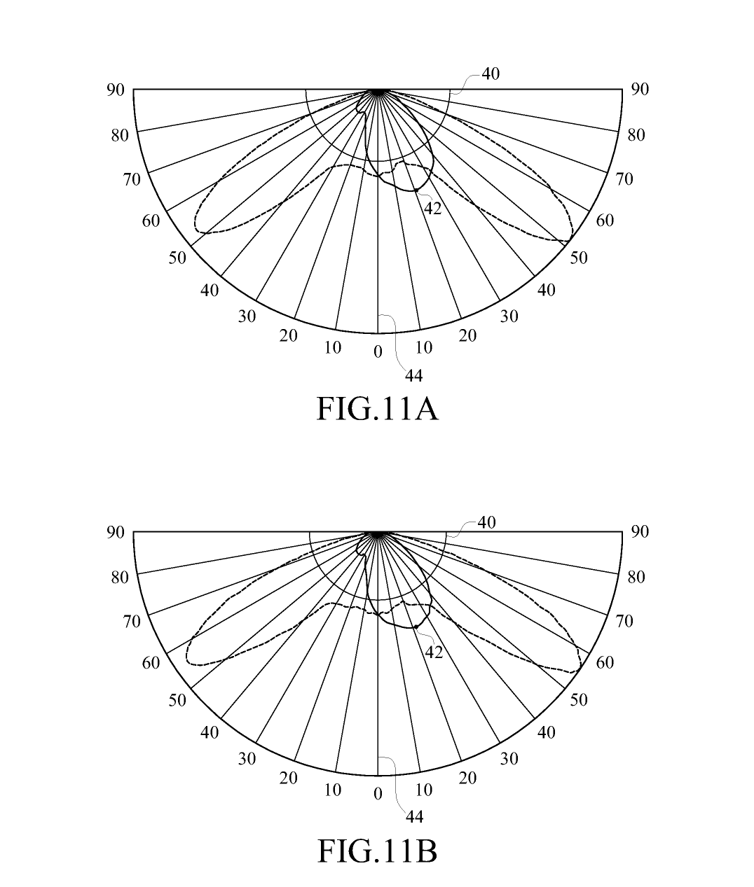

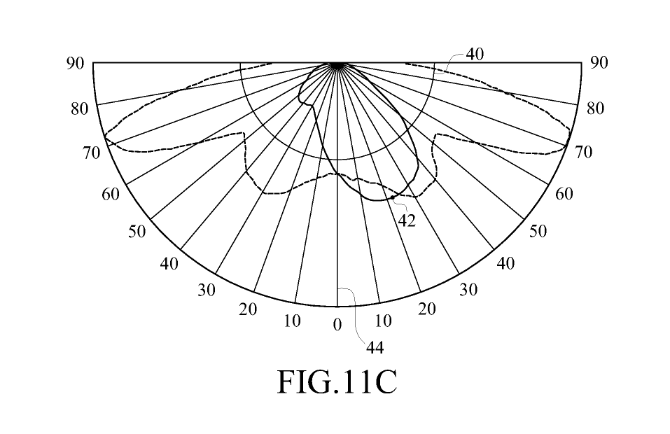

The optical lens 204 may influence the luminous intensity distribution of the light 60 after the light 60 passes through the optical lens 204 with the different relative distances between the incident curved surface 206 and the emitting curved surface 210. FIGS. 11A, 11B, and 11C are luminous intensity distribution curves of the optical lenses in FIGS. 10A, 10B, and 10C respectively. The optical lenses 204 of the fourth embodiment, the fifth embodiment, and the sixth embodiment have different first refraction angles 92 and different second refraction angles 94 respectively, and detailed results are shown in Table 5.

TABLE 5

| | First refraction angle | Second refraction angle |
|---|---|---|
| | (degrees) | (degrees) |
| Fourth embodiment | 105 | 44 |
| Fifth embodiment | 112 | 45 |
| Sixth embodiment | 145 | 47 |

It can be known from Table 5 that, as the relative distance between the incident curved surface 206 and the emitting curved surface 210 decreases, the first refraction angle 92 of the light 60 on the first plane (that is, the Y-Z plane) becomes larger. When the optical lens 204 is applied to a street lamp, since the first refraction angle 92 is the luminous intensity distribution of the light 60 in a length direction of the road, so that an optical lens 204 having a shorter relative distance between the incident curved surface 206 and the emitting curved surface 210 can project the light 60 to a longer road length, so as to increase an interval between two adjacent street lamps arranged in a second axial direction (that is, a Y direction), thereby decreasing the number of the street lamps arranged.

With the optical lens and the optical lens plate of the present invention, through the design of a first angle, the luminous intensity distribution of light passing through an optical lens on a second plane may be asymmetric. Through the design of a second angle, the luminous intensity distribution of light passing through the optical lens on the second plane may be asymmetric. Through the design of a lead angle surface and a third angle, the utilization of the light increases. Through the adjustment of a relative distance between a incident curved surface and a emitting curved surface, the first refraction angle of the light on the first plane is changed. The optical lens plate of the present invention is applicable to a lamp, wherein an asymmetric luminous intensity distribution is achieved through the design of a single type of optical lens. Therefore, the luminous intensity distribution curve of the light after passing through the optical lens and the optical lens plate of the present invention is asymmetric, and the problems such as light pollution, low light utilization, and high manufacturing cost due to the complex design in the prior art can be solved, when being applied to a street lamp. When the second refraction angle of the optical lens is larger, the optical lens is more applicable in street lamps for multilane road lighting.

What is claimed is:

1. An optical lens, applicable for receiving a light emitted from a light emitting diode (LED), wherein the LED comprises a first optical axis, and the optical lens comprises:
an incident curved surface;
a cone-shaped body; and
an emitting curved surface,
wherein the incident curved surface is used for receiving the light, the light has a first refraction angle on a first plane and a second refraction angle on a second plane after passing through the incident curved surface, the cone-shaped body, and the emitting curved surface, the first refraction angle is between 105 degrees and 145 degrees, the second refraction angle is between 38 degrees and 65 degrees, and the light is asymmetrically distributed on the second plane.

2. The optical lens according to claim 1, wherein the cone-shaped body comprises a first surface and a second surface, there is a first angle between the first surface and the second surface, and the first angle is between 10 degrees and 65 degrees.

3. The optical lens according to claim 2, wherein the incident curved surface comprises a second incident curved surface, the second incident curved surface comprises a first curved line, the first curved line comprises two first end points, there is a second angle between a connecting line between the first end points and the second surface, and the second angle is between 30 degrees and 60 degrees.

4. The optical lens according to claim 1, further comprising a lead angle surface.

5. The optical lens according to claim 4, wherein the lead angle surface comprises a first line segment, the first line segment comprises two second end points, there is a third angle between a connecting line between the second end points and the first optical axis, and the third angle is between 20 degrees and 50 degrees.

6. The optical lens according to claim 4, wherein the lead angle surface is a plane or a curved surface.

7. The optical lens according to claim 1, wherein the emitting curved surface is an M-shaped curved surface, the M-shaped curved surface comprises a central axis, and the central axis coincides with the first optical axis.

8. An optical lens plate, applicable to a lamp, wherein the lamp has a plurality of light emitting diodes (LEDs), each LED comprises a first optical axis and is used for emitting light, and the optical lens plate comprises:
a substrate; and
a plurality of optical lenses, disposed on the substrate, wherein the optical lenses correspond to the LEDs, each optical lens comprises an incident curved surface, a cone-shaped body, and a emitting curved surface, the incident curved surface is used for receiving the light, the light has a first refraction angle on a first plane and a second refraction angle on a second plane after passing through the incident curved surface, the cone-shaped body, and the emitting curved surface, the first refraction angle is between 105 degrees and 145 degrees, the second refraction angle is between 38 degrees and 65 degrees, and the light is asymmetrically distributed on the second plane.

9. The optical lens plate according to claim 8, wherein the cone-shaped body comprises a first surface and a second surface, there is a first angle between the first surface and the second surface, and the first angle is between 10 degrees and 65 degrees.

10. The optical lens plate according to claim 9, wherein the incident curved surface comprises a second incident curved surface, the second incident curved surface comprises a first curved line, the first curved line comprises two first end points, there is a second angle between a connecting line between the first end points and the second surface, and the second angle is between 30 degrees and 60 degrees.

11. The optical lens plate according to claim 8, wherein the optical lens further comprises a lead angle surface.

12. The optical lens plate according to claim 11, wherein the lead angle surface comprises a first line segment, the first line segment comprises two second end points, there is a third angle between a connecting line between the second end points and the first optical axis, and the third angle is between 20 degrees and 50 degrees.

13. The optical lens plate according to claim 11, wherein the lead angle surface is a plane or a curved surface.

14. The optical lens plate according to claim 8, wherein the emitting curved surface is an M-shaped curved surface, the M-shaped curved surface comprises a central axis, and the central axis coincides with the first optical axis.
